(19) United States
(12) Patent Application Publication
(10) Pub. No.: US 2015/0294417 A1
(43) Pub. Date: Oct. 15, 2015

(54) SPOT FIXING AUCTION

(71) Applicant: CFPH, LLC, New York, NY (US)

(72) Inventor: Angelo Toglia, Norwalk, CT (US)

(21) Appl. No.: 14/683,727

(22) Filed: Apr. 10, 2015

Related U.S. Application Data
(60) Provisional application No. 61/977,943, filed on Apr. 10, 2014.

(51) Int. Cl. G06Q 40/04

(52) U.S. Cl. CPC G06Q 40/04

(57) ABSTRACT

Some embodiments may include a matching of desires to exchange one or more items (e.g., trade one currency for another currency). A market may receive desires to be on one side of a trade and desires to be on the other side of the trade. A price setter (e.g., fix publisher) may announce a price at some time. The market may match desires for the trade at the desired price to facilitate trading. The market may internalize trading desires to a trading entity before making those desire match with external desires.

### CROSS REFERENCE TO RELATED APPLICATIONS

This application claims priority to U.S. provisional application 61/977,943 filed Apr. 10, 2014, which is hereby incorporated herein by reference.

### FIELD

Some embodiments may generally relate to matching of buyers and sellers.

### BACKGROUND

Some embodiments may generally relate to matching of buyers and sellers.

### SUMMARY

The following should be understood as example embodiments, and not as claims.

A. An electronic exchange configured to: determine a future time when a matching event for a foreign exchange trade is to take place on the electronic exchange; receive a first order from a first trading entity of a first market participant, in which the first order indicates a buy in the matching event; after receiving the first order, receive a second order from a second market participant, in which the second order indicates a sell in the matching event; after receiving the second order, receive a third order from a second trading entity of the first market participant, in which the third order indicates a sell in the matching event; after receiving the third order, receive a fourth order from a third market participant, in which the fourth order indicates a buy in the matching event; after receiving the fourth order, receive a fifth order from a fourth market participant, in which the fifth order indicates a buy in the matching event; in response to the future time occurring, receive an indication of a price for the matching event; based on the first order and the third order being from a same market participant, matching the first order and the third order to create a trade at the price; and based on the second order and the fourth order being in time priority after matching the first order and the third order, matching the second order and the fourth order to create a trade at the price.

### BRIEF DESCRIPTION OF THE DRAWINGS

FIG. 1 illustrates and example system that may be used in some embodiments.

FIG. 2 illustrates an example method that may be used in some embodiments.

FIG. 3 illustrates an example interface that may be used in some embodiments.

### DETAILED DESCRIPTION

### I. Example Embodiments

Trading takes place in many forms through many venues. This complex network raises many potential issues ranging from difficulties obtaining a “good” price when the prices for items vary across venues, to liability valuation when trades are kept dark and not reported to the public, to central bank policy making in the face of global uncertainty such as in widely unregulated foreign exchange markets. Various embodiments operate in this complex landscape and bring about some levels of ease and certainty to traders. It should be recognized that when embodiments are discussed that those embodiments are non-limiting examples, that other embodiments may include some, none, or all or the described features in any combination or arrangement. It should also be recognized that while some example embodiments may be discussed in terms of a single currency transaction or FX trading in general, that such examples are given as non-limiting examples only for the sake of explaining features of some embodiments in an understandable manner. Various embodiments may relate to an exchange, a trade and/or a match of interests related to one or more items such as financial instruments, physical goods, intellectual properties, commodities, securities, foreign exchange obligations, currency purchases, intangible goods, royalty streams, wagers, obligations to pay or deliver based on uncertain future events, and so on.

The foreign exchange market is used herein as an example of some of the functionality of some embodiments. The foreign exchange market is difficult to navigate. Many transactions are unregulated and unreported. In a world where countless transactions are happening across the globe at any moment, this can lead to a great amount of uncertainty about where the market stands at any particular moment and how one any one transaction relates to any other transaction. This manifests itself, for example, when one entity finds itself on both the bidding and offering side of a currency transaction. One might imagine that this situation should not occur. However, the chaotic world of currency trading allows just such a situation to occur. For ease of explanation, most of the examples are given in terms of a specific currency pair—the Euros for US dollars trade. It should be recognized that this trade is non-limiting. Other currency pairs (e.g., even pairs that are not market based but have an exchange rate set by a central bank) or items that are not currency may be traded in other embodiments.

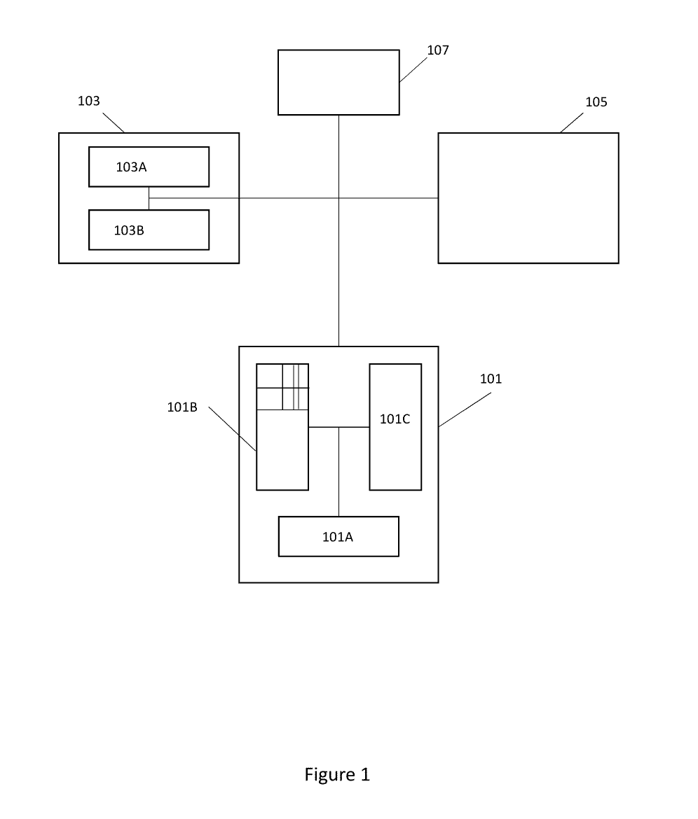

FIG. 1 illustrates an example system that may be used in some embodiments. The illustrated embodiment includes a matching platform 101, a first participant 103, a second participant 105 and a pricing source 107. It should be recognized that this example system is given as an illustration only for the purposes of illustrating some features of some embodiments. Notably, a typical real world embodiment might have many, many participants rather than the simplified two participants. However, it is easier to illustrate some features when the discussion is limited to two participants. Additionally, there may be any number of pricing sources used in various embodiment to enable a variety of currency trading or other item trading at various times or with various price mechanisms used. However, once again, some features are easier illustrated showing a single source. One of ordinary skill in the art will recognize how to scale some of these feature based on the description of this simplified embodiment.

Using such a system first participant 103 may engage in an auction for the exchange of currencies. Such a system may enable a large number of parties to engage in the trading of large amounts of currencies or other items at a rapid speed and using a pricing mechanism that increases trust that a fair exchange has occurred and reduces unmatched internal desires. Such a system may in some embodiments also increase the transparency of an often hidden or unregulated market improving the ability of observers and regulators who have a demand for information about currency or other item trading.

Matching platform 101 may include an exchange, an auction venue, a volume matching venue, and or any other desired platform that may match desires. A matching platform may facilitate trading among any number of participants. A matching platform, for example, may include an electronic system that receives orders to buy and orders to sell a currency. A matching platform may maintain queues for buy orders (e.g., bids) and queues for sell orders (e.g., offers). A matching platform may match orders in a buy queue and orders in a sell queue to fulfill the orders in each queue against one another. A matching platform may communicate such a match to a clearinghouse that may execute a trade that fulfills matched orders. A clearinghouse may take possession of an item being sold from a seller and take possession of an amount of money offered for the item from a buyer. The clearing house may then transfer the money to the seller and the item to the buyer. A matching platform may notify participants of successful and/or unsuccessful trades and/or matches. A matching platform and/or clearinghouse may take a fee for providing such services (e.g., a commission for each trade executed, a percentage of an amount of a total sale or purchase, a flat amount per trade order, etc.).

A matching platform may include a matching engine 101A. Such a matching engine may execute instructions to determine when one or more buy orders and one or more sell order match one another. A wide variety or orders and matching criteria may be used in various embodiments. These may differ for item type, price mechanism, participant, and so on in various embodiments. Software, such as that stored in registers, RAM, static memory and/or other memory, may instruct a matching engine on how to properly determine matches among orders. A matching engine may access by and sell desires from a buy queue and a sell queue to determine matches. In a non-limiting example simplified for understandability, a single buy order for ten Euros from a first participant may be matched against a single sell order for ten Euros from a second participant. These matched orders may cause a trade for the ten Euros to be executed. Further examples of matching and/or manners of determining matches are given elsewhere herein.

A matching platform may include a sell queue 101C. A sell queue may include a data structure (e.g., a queue embodied in data of a storage device, a set embodied in data in a memory, etc.) that stores information about sell desires that the matching platform receives. A communications adapter of a matching platform may receive data from a participant (e.g., the second participant) that identifies a desire to sell an item. The matching platform may store information that defines that desire (e.g., a quantity, an entity, a side of a trade, a currency, a time, and/or other information) in the sell queue along with information about other desires to sell. Collectively, a sell queue may store the desires of participants to sell items. A sell queue may be ordered or unordered. In some ordered embodiments, that ordering may be used to help determine matching by the matching engine. In some unordered embodiments, some other information may be used to help determine matching, such as a time of receipt or other priority mechanism.

A matching platform may include a buy queue 101B. A buy queue may include a data structure similar to a sell queue and may operate similarly to a sell queue except with buy desires rather than sell desires. Collectively, a buy queue may store the desires of participants to buy items.

Desires may be stored in queues with certain pieces of information. For example, a desire may be defined by an amount of an item wanted for sale or purchase, a side (i.e., sale or purchase), a time (e.g., when a desire is transmitted to or received by a trading platform), an originator (e.g., a participant that submit an order), a matching event (e.g., a particular auction and/or other matching event), and/or other desired information. Such information may be stored for each entry in a queue. That information may be used to determine matches and/or otherwise facilitate trading. A desire may be referred to as an order in some embodiments. But in some contexts an order may include certain connotations that may not necessarily be present in all embodiments. Accordingly, some references are made to desires to buy or sell rather than orders to buy or sell to show that the embodiments are not limited to whatever implications the term order may carry. Buy queue 101B illustrates having two such desires and/or orders stored in the buy queue.

Components of a matching platform may be connected by a communication network such a network may include a data bus or other network such as a LAN. In some embodiments, such a network may include a low latency, high-speed network that may increase rapid processing of trading desires.

Some embodiments may include multiple sell queues, multiple buy queues and/or multiple matching engines. For example, each item matched through matching platform may have its own matching engine and queues. As another example, by controlling the timing of the matching engine's processing, a single matching engine may service multiple sets of queues with each set of queues being associated with a single item a trading. A trading platform may include any other desired components, such as an auditing system, a reporting system, a data storage, an administrative interface, an API that allows access to orders or submission of orders, and so on.

As indicated at 103, some embodiments may include a first participant. A participant may include an entity that has a desire to trade in an item. Such a desire may include a desire to buy and/or a desire to sell a currency. An entity may include an investing institution that acts for money management purposes, a broker, a bank, and/or any desired entity.

In a complex market, a single participant such as that of the illustrated first participant may be made up of a plurality of sub-participants. For example, an algorithmic trading participant may engage in trading through two or more algorithms. As another example, a bank or hedge fund may engage in trading through two or more trade desks. As yet another example, a broker may engage in trading for more than one client and/or a brokerage agency may engage in trading for more than one client through more than one broker. FIG. 1 illustrates such a situation with actors 103A and 103B. These may be any form of entity responsible for submitting desires to trade to a matching platform (e.g., traders, brokers, computers, algos, APIs, interfaces, etc.).

First participant 103 may include one or more computing devices. Such devices may enable traders to submit orders, may run algorithms, may provide interfaces, and/or may otherwise facilitate the submission of one or more or trading desires to a trading platform 101. A general purpose computer may be operated to provide such functionality with proper programming. A first participant may submit a trading desire through a communication network to a trading platform indicating a desire to buy or sell some amount of an identified item. Such a transmission may include use of a trading platform API to submit an order and/or any other type of transmission in any agreed upon format that the trading platform recognizes (e.g., a transmission encrypted using a public key of the trading platform and/or encoded according to a packet encoding scheme made available by the trading platform).

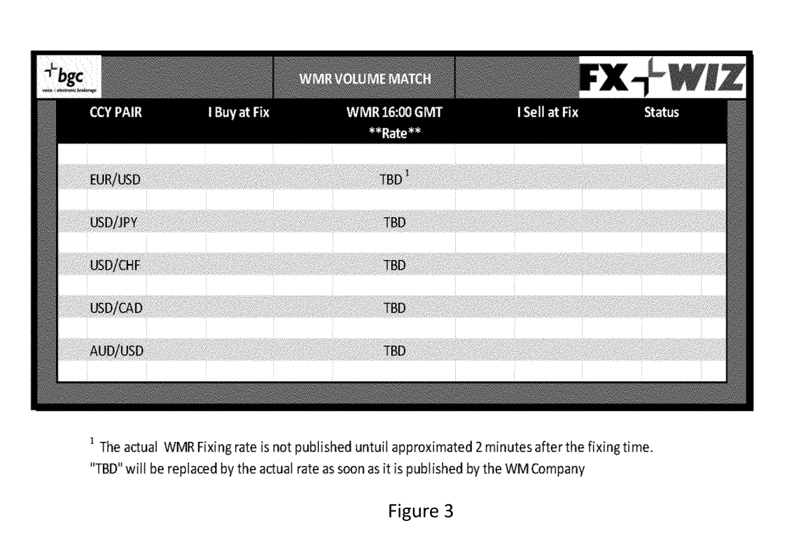

As an example, an algorithm 103A may determine that a trade is desired to buy a currency. The algorithm 103A may submit a buy order through a local LAN of the first participant through the internet and to the trading platform by accessing the trading platforms API. The trading platform may receive the information and populate a buy queue with that information. As another example, a broker 103B of the first participant may receive from a client an interest to sell an item. The broker may enter information into a trading platform interface such as that of FIG. 3. The broker may actuate a control (e.g., press a button) and in response a broker computing device may transmit information identifying the desire to sell in a format that the trading platform recognizes (e.g., a transmission encrypted using a public key of the trading platform and/or encoded according to a packet encoding scheme made available by the trading platform). The trading platform may receive the information and add the order embodied in the information as an entry to a sell queue.

As indicated at 105, some embodiments may include a second participant. A second participant may be similar to a first participant. A second participant may submit desires to buy or sell one or more items. A second participant may be a same type or different type of participant and may have similar or different trading desires and/or take any number of similar or different actions.

As discussed above, it should be recognized that in the real world, an embodiment is likely to have a large number of diverse participants and a trading platform may be tasked with processing the trading desires of all of those participants. The description of the first participant above shows some examples of types and characteristic and interests of some example participants but it should be recognized that the world is even more diverse than the few examples given herein and that embodiments are not limited to such example participants.

As indicated at 107, some embodiments may include a pricing source. A pricing source may include an entity that sets a price for a match. For example, a pricing source may a source of a FX fix such as WM/Reuters. It should be recognized that a trading platform may use any number of pricing sources to set any number of match prices as desired and that WM/Reuters FX fix is given as a non-limiting example only for the illustration of some example functionality. A price may be determined by the price source (e.g., the 2 PM WMR price fix) according to any method desired by the price source (e.g., in the case of WM/Reuters, a proprietary algorithm for determining the price based on one or more observable market conditions; as another example, in the case of a central bank set price, the price that policy makers deem to be appropriate for a country based on their poly goals; etc.). A price may be determined at one or more times (e.g., ongoing, periodically, continuously, occasionally, at a fixed set of times, at 2 pm each weekday, at 9 am each week day, etc.). Different price sources may determine prices with different methods and/or at different times. Complex algorithms may take into account a variety of information for determining a price (e.g., global demand, policy effect estimations, etc.). A computing device may use such information as input to determine a price.

A price source may publish a price in response to determining the price. For example, in response to determining the 2 PM WMR fix, WM/Reuters may publish a price (i.e. a set of currency pair exchange rates). For example, an electronic transmission indicating the price may be made at, for example, 2:02 pm each weekday after the price is determined for the 2 PM WMR fix. Such a publication may take any desired form such as a publication in a public location that is monitored by the trading platform, a direct and/or private transmission to the trading platform such as in a csv file format or other encoding, an access may be allowed for the trading platform to obtain that information such as addition to an FTP site, and so on.

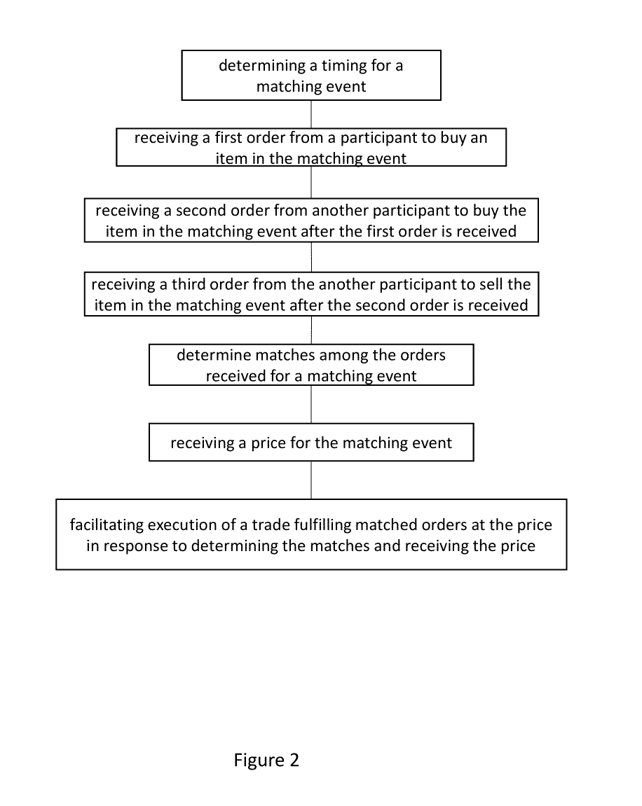

The trading platform may use that price as a set price for a particular matching event. Desires in a buy queue and a sell queue may be matched at a price in response to receiving a price for the event. Further Examples of such matching events are given elsewhere herein (e.g., with respect to the method of FIG. 2).

A communication network may communicatively couple one or more components of FIG. 1. For example, the components may be couple through the internet. Such coupling may allow a participants to transmit and/or receive information to/from the trading platform, for example. Such coupling may allow communication in one or two direction between the trading platform and the pricing source. Various levels of encryption, compression, and/or encoding may be applied to information transmitted between components. In some embodiments, more direct links may be established to decrease latency and/or otherwise improve transmission speeds.

Although the various components shown in FIG. 1 may be owned and/or operated by different entities in some embodiments, they may nonetheless operate together as a system that facilitates trading. A method that one or more components of such a system may perform to facilitate such trading is illustrated in FIG. 2.

FIG. 2 illustrates an example method that may be performed in some embodiments. Such a method may be performed by a matching platform, one or more components of FIG. 1, one or more computing devices such as servers, and/or one or more other elements as desired. Such a method may enable periodic matching of desires for an exchange of an item at a price set by a price source.

As indicated, some embodiment may include determining a timing for a matching event. A matching event may be referred to as an auction or a volume match in some embodiments. For example, some embodiments may include determining that an event is based on a particular price publication such as the 2 pm WMR fix. That particular price publication has a time associated therewith. That time may be a publication time such as 2:02 pm for the WMR 2 pm fix or a time of pricing such as 2 pm for the 2 pm WMR fix that indicates the time at which the fix price is valid. It should be recognized that such times are given as examples only and that any times may be used by various price sources and/or that a price source may have any number of times used including for example a price time and a publication time that are the same or occur in reverse order.

A determination may be made for an end of acceptance of orders for a matching event. Such a determination may be based on a determination of a price or publication time. For example, the earlier of a price or publication time may be used, the later of a price or publication time may be used, 5 minutes before one of the price or publication time may be used, 1 minute before one of said times may be used, n minutes before one of said times may be used, n seconds before one of said times may be used, and so on. Orders that are received before such a time may qualify for matching in the matching event.

In some embodiments, a determination of a time to begin accepting orders for a matching event may be made. Such a determination may be based on a time for an end of acceptance of orders for the matching event, may be based on a time for an end of accepting orders for another matching event, may be based on a set amount of time for allowing orders, and/or may be based on any desired information.

Between such an ending time and beginning time for a matching event, orders that are receive for the matching event may be accepted for the matching event. Outside of that time, orders for the matching event may be rejected. Those orders may be accepted for another matching event.

In some embodiments, there may be no beginning time for a matching event. Rather, users may submit orders before an event as they desire without a restriction. For example, an order may be submitted years or decades in advance for a particular event if no such beginning time restriction is applied.

As indicated, some embodiments may include receiving a first order from a participant to buy an item in the matching event. The first order may identify an amount of an item, a side of a trade, and/or an identity of a submitter (e.g., a bank). For example, the second participant in FIG. 1 may submit an order to buy ten Euros in the matching event by using an API of the matching platform. The matching platform may receive that order (e.g., through the internet or other network).

A determination may be made that the received order is for the matching event. Such a determination may be based on a time when the order is received (e.g., if order is received between an end time and a start time of a matching event then it may be assigned to the event). Such a determination may be based on information received that defines the order as being for the matching event (e.g., part of received data defining the order may indicate the matching event). Such a determination regarding an order may be made in response to receiving said order.

As indicated, some embodiments may include receiving a second order from another participant to buy the item in the matching event after the first order is received. Receiving such an order may take a form similar to receiving the first order. For example, the first participant in FIG. 1 may submit an order to buy ten Euros in the matching event by using an API of the matching platform. The matching platform may receive that order.

Some embodiments may include determining that the second order is for the matching event. Such a determination may take a form similar to such a determination made with respect to the first order.

As indicated, some embodiments may include receiving a third order from the another participant to sell the item in the matching event after the second order is received. Receiving such an order may take a form similar to receiving the first order and/or the second order. For example, the first participant in FIG. 1 may submit an order to sell fifteen Euros in the matching event by using an API of the matching platform. The matching platform may receive that order.

Some embodiments may include determining that the third order is for the matching event. Such a determination may take a form similar to such a determination made with respect to the first order and/or the second order.

It should be recognized that in action, many orders from many participants are expected to be received. This example is given in terms of two participants and three orders to illustrate some of the functionality that may be available in some embodiments. Such functionality may scale to any number of participants and any number of orders as would be understood by one of ordinary skill in the art. It is easier to illustrate such functionality in this controlled and limited case.

As indicated, some embodiments may determine matches among orders received for a matching event. A buy order may match with a sell order.

In some embodiments, order matching may take place based on a time priority mechanism such as a first in first out manner. For example a buy order to buy 5 items may match with a sell order to sell 3 items. A remaining buy order for 2 items may be left. That remaining order may match with a sell order for 2 items thereby satisfying orders in that limited example. In other embodiments, order matching may take place in a pro rata method. For example, two buy orders each for 5 items may be pending in a buy queue. A sell order for 2 items may be in the sell queue. When matches are determined, each of the buy orders may be matched with the sell order at a 1 item level, leaving 2 buy orders each for 4 items in the buy queue. Some embodiments may support various order types such as all-or-nones where an order is not matched at all unless it can be matched completely. Order type and matching example are given as non-limiting explanations of possible functionality only.

Matching may take place in a variety of manners. For example, in some embodiments, matching may be an ongoing process. As orders come in that match with one another the orders may be matched together. As another example, orders may be matched at a set time such as in response to an end of a period for a matching event, in response to a price being determined, etc. In some such embodiment there may be multiple times rather than a single time for matching (e.g., every hour, every ten minutes, etc.). As a still further example, order matching may take a hybrid form. In such a situation, orders may sometimes be matched in an ongoing manner and sometimes be matched at a point in time manner (e.g., last hour of a period for accepting orders may be an ongoing manner and before then may be a point in time manner, the reverse may occur, any amount of time may be used other than an hour). While orders wait to be matched, the orders may pend in a buy and/or sell queue.

Some embodiments match with an attempt to internalize matches in a participant. Orders on opposing sides of a trade may be matched together with one another if they are from a same participant even if they would not be matched together based on a time priority mechanism.

In the example given of the first order, second order and third order in discussing FIG. 2, a first order was received to buy ten Euros from the second participant of FIG. 1, then a second order to buy ten euros was received from first participant of FIG. 1, and then a third order to sell fifteen Euros was received from the first participant of FIG. 1. If an internalization mechanism were not applied, the first order and third orders would be matched first leaving a sell order for five Euros to be matched with the second order. This would result in the first participant being left with a five Euro demand unfulfilled.

In an embodiment with internalization, a determination may be made to give priority to match the second order and the third order based on the second order and the third order being from a same participant. In response to receiving the third order for example in an ongoing matching embodiment, a determination may be made that a matching order from the same participant is pending (e.g., buy searching the buy queue for orders from the first participant). In response to such a determination, the sell order may first be matched with any found orders (e.g., in a time priority if there were multiple matching orders incentivizing early submission, in a reverse time priority if there were multiple matching orders laving any unmatched with a highest time priority). In the above example, with internalization, the outcome of matching changes to the second order's demand for ten Euros being match in full with the third order and then the remaining five sell demand in the third order being matched with the first order. This would leave a demand to buy five Euros from the second participant unfulfilled.

In this example, internalization works out the same if a system uses an ongoing or point in time or hybrid matching system. However, the results may differ if the ordering of orders changes. For example, if the third order actually came in first, the outcomes of an ongoing matching system and a point in time matching system would differ. In an ongoing matching system, the third order would be matched with the first order in response to the first order being received (i.e., because at that time there is no matching order form the first participant since the second order has not yet been received in this modified example). Then the remainder of the third order would pend until the second order is received. In a point in time example, assuming the point in time occur after all of the orders are received, the second and third orders would be matched first as discussed above and then the reminder of the third order would be matched with the first order. Hybrid embodiments may differ in their outcomes depending on the hybrid used and the timing of orders, but one of ordinary skill would understand how those might work based on these explanations.

Such internalizations may bring an element of order to the fast-paced chaotic and global world of trading, especially that of currency trading. Participants may generally have a preference to have their own client's or their own traders' or their own algorithms' demand filled first so that they are not left with unfilled demand. Internalization allows this to happen through a matching venue.

It should be recognized that while examples are given in terms of a single participant having internalized orders that in practice many participants may be submitting orders and have those orders internalized a when possible. Orders or order portions that remain pending after an attempt to internalize may be matched together with other orders that did not have internalized matches.

In some embodiments, a source of an order may be notified of a match in response to a determination of the match. Order may be cancelable before a match is found. After a match is found, the orders may no longer be cancelable. The match then may act as a binding trade commitment without knowledge of the price for the trade. In this way a participant may know that they no longer have risk of not having a matched order filled. In other embodiments, cancelation may be constrained after an order is submitted before a match as well.

Information about matches may be stored. Such storage of information may be useful for auditing purposes, commission charging purposes, and/or in the event that any dispute arises.

In response to a determination of a match, some embodiments may include reporting that match publicly or to someone other than a participant. This reporting may be done in an ongoing manner (e.g., before a price is determined) and/or a batch manner (e.g., after a price is determined). This reporting may be used by the market as a sign of demand for trading. This reporting may be used by regulators and/or participants to increase confidence in a market for currencies by showing that an auditable trail for currency transactions is available. The reporting may keep participant identities confidential. The reporting may keep unfilled demand confidential to avoid moving the market. In other embodiments, reporting may show unfilled demand to increase information in the market. In some embodiments, reporting may be limited to matches over a threshold size (e.g., 1 million dollars, 100 contracts, 1000 contract, 10000 contracts, etc.). In some embodiments, reporting may be delayed (e.g., until after an event, some number of minutes, etc.). In some embodiments reporting may be limited to and/or about certain types of participants (e.g., institutional participants, etc.).

As indicated, some embodiments may include receiving a price for the matching event. For example the price may be received from a pricing source in the form of an electronic document, may be published in a trusted and known location such as a website, and so on. The WMR fix price, for example may be transmitted from WM/Reuters to the matching platform in the form of a data file in an agreed upon format.

As indicated, some embodiments may include facilitating execution of a trade fulfilling matched orders at the price in response to determining the matches and receiving the price. For example, the trades in the examples given above might be executed at a WMR 2 pm price of 0.75 Euros per USD in response to receiving that price from WM/Reuters. Facilitating execution may include actually executing an exchange and/or communicating with a clearinghouse to execute the exchange.

Some embodiments may include notifying participants and/or making a reporting in response to facilitating execution of a trade. Such reporting and/or notification may be similar to the reporting and/or notification discussed with response to matching.

It should be recognized that this example method is given as a non-limiting example only to show some possible functionality of some embodiments. Other embodiments may include other actions, other orderings, addition or fewer actions, same or no actions, and so on. Various embodiments may be combined together in any manner.

It should also be recognized that in practice a large number of actors and orders and trades are expected. Although the example is given as terms of a single Euro to dollar currency trade, many currency pairs may be traded simultaneously through a matching platform performing (e.g., a matching platform performing a similar method for each such currency pair) the WMR 2 pm fix for example release prices for a plurality of currency pairs. Each of those pairs may be processed by a matching platform to allow trading in each of those currency pairs.

Although examples are given in terms of a pricing source determining a fix price, some embodiments may not fully rely on such a pricing source. Such embodiments may determine a price in some other manner. For example, based on perceived supply and demand, by aggregating multiple fix prices, and so on.

Some embodiments may include numerous matching events. For example each data that the WMR 2 PM fix is release, a matching event may be held for that fix. Each day there may be numerous matching events such as one for each fix announced by one or more sources. In some embodiments, when one matching event ends, another matching event may begin. In some embodiments, a time when an order is received may be used to determine which matching event it is assigned to. Such continuous matching events may enable a form of continuous matching of interests for a period price announcement.

In response to an end of a matching event, some embodiments may take action with respect to unmatched orders. For example, such orders may be rolled into a next matching event. As another example, a second auction that is different from a pre-planned matching event at the same price or a different price determined in any desired manner may be held for the unmatched orders. In some embodiments, such a second auction may be triggered if the unmatched demand exceeds a threshold. In some embodiments, anyone may participate in such a second auction. On other embodiments, participation may be limited (e.g., to parties that submitted orders in the first auction, to parties that submitted orders of a certain size in the first auction, to parties that did not participate in the first auction, and so on in any combination. For example, in some embodiments, a future auction may be planned for a 4 pm fix after a 2 pm fix auction ends. A second auction may be triggered using a 3 pm fix price. The 3pm auction may normally not be held except where there is imbalance in the 2 pm auction. In another example where there is a 2 pm and a 4 pm planned auction but the 2 pm fix results in an imbalance, a separate 4 pm auction may be held with just the specific invitees allows to participate in the separate auction. The general public may be allowed to participate in the normal 4 pm auction.

In some embodiments, no action may be taken with respect to such unfilled order. The orders may be left unfilled without an attempt to otherwise fill them.

FIG. 3 illustrates an example interface that may be used in some embodiment to facilitate trading through a trading platform employing such matching event functionality. This is an illustration of an interface that may enable a trader to submit an order for a 16:00 GMT WMR Fix Auction.

A matching session in which the rate is set to “TBD” (To Be Determined) is shown here. A trader may use this GUI to enter a desired quantity of a trade and submit that order to the matching platform (e.g., entering an amount in a cell such as the buy at fix cell in the EUE/USD column to indicate the amount of contracts wanted to buy at the fix price, pressing a submit button or the enter key). In response to a fix price being published a GUI may change from TBD to show a determined price. A trader may track pending and/or submitted orders through such an interface in some embodiments.

It should be recognized that this interface is given as an example only and that any desired interface and/or method of interacting with a matching platform may be used in a variety of embodiments.

Various example are given in terms of orders, and buy or selling currency. Terminology and examples are given in a manner that illustrates both the flexibility of some embodiments and the applicability of certain features to specific problems. Notably, terms such as bid and offer or buying and selling are not currency trading terms. Left side and right side or make and take terminology may be more applicable for the trading of some items. However, that terminology is not limiting as is clearly evident by the description herein. Moreover, the types of items traded are not limiting in any manner. The discussion again illustrates that. Currency trading for example may include trading lots of one currency for lots of another currency. One currency may be set as a base currency and stay static, say at 1 face value while the other currency (the quote currency) may change value. In that sense, the price of purchasing the 1 of the face value amount may be the fluctuating amount in the other currency. Traders may purchase and or sell currencies in lots of 100000, 10000, 1000, and/or any size number. A discussion of trading an item may mean trading a currency and/or a lot of a currency at a set lot size. For example, a trader may submit an order to buy 1 lot of Euros. That lot may be actually a face value of 10000 Euros. As another example, a trader may buy 10 lots of 1000 X currencies for 250 of Y currencies for each lot and in that way may have the obligation to provide 2500 Y currency and the right to receive 10000 X currency. Currency trading may include trading related to spot rates, forward rates, ndf rates, and so on. These examples and terminology are given to show that the trading examples are not limiting and may be adapted to trading in a wide variety of items in a wide variety of ways.

The following sections provide a guide to interpreting the present application.

### II. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not necessarily limited to”, unless expressly specified otherwise. Thus, for example, the sentence “the portfolio includes a red widget and a blue widget” means the portfolio includes the red widget and the blue widget, but may include something else.

The term “consisting of” and variations thereof means “including and limited to”, unless expressly specified otherwise. Thus, for example, the sentence “the portfolio consists of a red widget and a blue widget” means the portfolio includes the red widget and the blue widget, but does not include anything else.

The term “compose” and variations thereof means “to make up the constituent parts of, component of or member of”, unless expressly specified otherwise. Thus, for example, the sentence “the red widget and the blue widget compose a portfolio” means the portfolio includes the red widget and the blue widget.

The term “exclusively compose” and variations thereof means “to make up exclusively the constituent parts of, to be the only components of or to be the only members of”, unless expressly specified otherwise. Thus, for example, the sentence “the red widget and the blue widget exclusively compose a portfolio” means the portfolio consists of the red widget and the blue widget, and nothing else.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### III. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### IV. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### V. Disclosed Examples and Terminology Are Not Limiting

Neither the Title (set forth at the beginning of the first page of the present application) nor the Abstract (set forth at the end of the present application) is to be taken as limiting in any way as the scope of the disclosed invention(s), is to be used in interpreting the meaning of any claim or is to be used in limiting the scope of any claim. An Abstract has been included in this application merely because an Abstract is required under 37 C.F.R. §1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

All disclosed embodiment are not necessarily covered by the claims (even including all pending, amended, issued and canceled claims). In addition, an embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### VI. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VII. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### XI. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

### XX. Alternative Technologies

It will be understood that the technologies described herein for making, using, or practicing various embodiments are but a subset of the possible technologies that may be used for the same or similar purposes. The particular technologies described herein are not to be construed as limiting. Rather, various embodiments contemplate alternate technologies for making, using, or practicing various embodiments.

1. An electronic exchange configured to:
determine a future time when a matching event for a foreign exchange trade is to take place on the electronic exchange;
receive a first order from a first trading entity of a first market participant, in which the first order indicates a buy in the matching event;
after receiving the first order, receive a second order from a second market participant, in which the second order indicates a sell in the matching event;
after receiving the second order, receive a third order from a second trading entity of the first market participant, in which the third order indicates a sell in the matching event;
after receiving the third order, receive a fourth order from a third market participant, in which the fourth order indicates a buy in the matching event;
after receiving the fourth order, receive a fifth order from a fourth market participant, in which the fifth order indicates a buy in the matching event;
in response to the future time occurring, receive an indication of a price for the matching event;
based on the first order and the third order being from a same market participant, matching the first order and the third order to create a trade at the price; and
based on the second order and the fourth order being in time priority after matching the first order and the third order, matching the second order and the fourth order to create a trade at the price.
